(19) United States
(12) Patent Application Publication
(10) Pub. No.: US 2005/0149374 A1
(43) Pub. Date: Jul. 7, 2005

(54) Tow management system

(76) Inventor: Sushil K. Garg, Laguna Hill, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/973,940

(22) Filed: Oct. 26, 2004

Related U.S. Application Data
(63) Continuation of application No. 09/726,374, filed on Nov. 30, 2000, now abandoned.

(51) Int. Cl. G06F 17/60

(52) U.S. Cl. 705/9

(57) ABSTRACT

The present invention is directed to a software based method and apparatus for managing all aspects of the tracking and dispatch industry, and in particular managing all aspects of a vehicle tow. The present invention allows a tower with a computer connection to use the computer connection to access a database that is maintained by a third party. Additionally, the system of the present invention integrates lien sale information with tow management information. The present invention is java based and utilizes click and drag features. Additionally, the software and system of the present invention allows for integration with other dispatching software packages.

### CROSS-REFERENCE TO RELATED APPLICATIONS

The present application is related to the application entitled LAW ENFORCEMENT TOW SYSTEM filed on Oct. 31, 2000, the disclosure of which is herein incorporated by reference.

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### STATEMENT REGARDING FEDERALLY SPONSORED RESEARCH OR DEVELOPMENT

Not applicable.

### REFERENCE TO A “MICROFICHE APPENDIX.”

Not applicable.

### BACKGROUND OF THE INVENTION

(1) Field of the Invention

The present invention relates generally to the tracking and dispatch industry and more particularly to a system for managing all the informational needs related to a motor vehicle tow.

(2) Description of the Related Art Including Information Disclosed Under 37 CFR 1.97 and 37 CFR 1.98

The vehicle tow process typically involves tedious and repetitive data collection and record keeping tasks. Typically, the person who requests a tow most obtain descriptive data on the vehicle being towed and communicate this data to a tow dispatcher. The tow dispatcher must then transcribe the data, determine the type of equipment necessary and subsequently dispatch a tow truck or other tow equipment to the scene. Typically the tow truck driver must also transcribe this data as well.

After the tow request is dispatched, additional record keeping is required. This record keeping entails tracking mileage, time spent on a tow, and the vehicle's destination which the dispatch may know in advance or may remain unknown until the tow equipment arrives on the scene. After the tow is completed, the vehicle typically will incur storage charges until it is released, or subsequently sold or scrapped.

Manual systems that are used for tow management record keeping require that the various records utilized in the tow process, for example the dispatch record and tow record be matched together. If a record is misplaced, the tower may lose revenue.

Software systems are available for tow management. However, these systems require a tower to purchase computer hardware with sufficient storage capacity for all the necessary records. The present systems do not store lien sale information or have the means or capability to link lien sale information to the original tow request. The present systems are based on older software technology which oftentimes are character based. Additionally, these software packages do not have integration capabilities with dispatch systems or other information systems not within the tower's domain.

Therefore, it is an object of the present invention to provide a software base system which minimizes a towers hardware investment. Another object of the present invention is to integrate lien sale data with the tow record. Yet another object of the present invention is to incorporate modern software technology such as JAVA for better performance and click and drag capabilities for ease of use. Still another object of the present invention is to provide a software based system which may be integrated with other dispatch and tracking systems utilizing a computer connection.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF SUMMARY OF THE INVENTION

In view of the aforementioned needs, the invention contemplates a software based system client-server system. The present invention contemplates utilizing an Application Service Provider (“ASP”) connected to a plurality of towers. The ASP would provide a server comprising hardware, data storage space, and server software for storing and maintaining tow records. A computer connection would allow a tower utilizing software such as a web browser to connect to the ASP.

The present invention also contemplates the integration of lien sale data with tow records. The lien sale data would include dates when the lien sale started, when division of motor vehicle requests were sent and received, date when a lien notice was sent, the date the clear date and the actual date. Additionally data pertaining to parties notified such owner or lienholder is stored. Finally, sale data such as the sale price and party purchasing the vehicle are stored.

Another aspect of the present invention is the capability to integrate with other dispatch and tracking systems via the computer connection. This enables a tower's customers to utilize their own software and to communicate the tow request electronically, eliminating additional manual transcribing which is labor intensive and prone to error. This also enables a tower's customer to track a tow request. For example, an insurance company may desire to inspect a vehicle it had towed for hidden damage or track storage costs.

Additionally, the present invention is based on Java technology, giving the present invention superior performance characteristics over the prior art and features modern drag and drop capabilities which makes the present invention easier to use than the character based systems of the prior art.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### BRIEF DESCRIPTION OF THE VIEWS OF THE DRAWING

The drawings illustrate the best mode presently contemplated of carrying out the invention.

This the drawings:

FIG. 1 is a block diagram illustrating the major components of the present invention;

FIG. 2 is an example of the main call taking screen;

FIG. 3 is a detailed view of the general section of the main call taking screen;

FIG. 4 is a detailed view of the vehicle section of the main call taking screen;

FIG. 5 is a detailed view of the location section of the main call taking screen;

FIG. 6 is a detailed view of the destination section of the main call taking screen;

FIG. 7 is a detailed view of the motor club section of the main call taking screen;

FIG. 8 is a detailed view of the owner/interested parties section of the main call taking screen;

FIG. 9 is a detailed view of an example of the lien sale screen;

FIG. 10 is a detailed view of an example of the invoice screen;

FIG. 11 is a detailed view of an example of the vehicle storage screen;

FIG. 12 is a detailed view of an example of the police information screen;

FIG. 13 is a detailed view of an example of the police hold screen;

FIG. 14 is a detailed view of an example of the Times/Mileage screen;

FIG. 15 is a detailed view of an example of the Search screen;

FIG. 16 is a detailed view of an example of the Dispatch Worksheet screen;

FIG. 17 is a detailed view of an example of a map for use with the present invention;

FIG. 18 is a detailed view of example of the customer information screen;

FIG. 19 is a detailed view of an example of the employee information screen;

FIG. 20 is a detailed view of an example of payment received screen;

FIG. 21 is a detailed view of an example of the security configuration screen.

### DETAILED DESCRIPTION OF INVENTION

The present invention is directed to a software based system for information management of all aspects of tow operations. The system tracks tow requests, the servicing of the tow requests, and disposition of the towed vehicle.

The present invention enables a tower to contract with an Application Service Provider (“ASP”) to minimize hardware costs. The ASP would provide all the necessary hardware, including data storage, server software and a computer connection for the Tow Management System. The ASP would then setup accounts with a plurality of towers, limiting each tower to only its own data records. A tower with client software, such as a web browser, may then utilize the computer connection for connecting with the ASP. The tower would then log into the system, the system controlling access via rights given to the login account.

The present invention enables a tower's customers to utilize a computer connection to integrate a customer's software system with the tower's system. This enables a customer to send a tow request to the tower and track the request while the vehicle is in the process of being towed, stored, and released or otherwise disposed. The customer would log into the tower's computer. Any information that the customer needs that is stored on the ASP would be routed through the tower's computer. The customer, tower, and ASP may all be connected on the same computer connection, for example the Internet or a PPP network. One such program available for integration with the software of the present invention is the Law Enforcement Tow System (“LETS”), available from eTrak, 3737 Birch Street, Newport Beach, Calif. 92660, Phone 949-567-7071. The LETS program enables a law enforcement agency to send a request over the computer connection to the tow management software and the request as will be described later to be automatically be displayed on the tow dispatcher's screen. As the tow request is dispatched and subsequent tow activities commence, the tow management software automatically sends notice of the various activities to the LETS system.

In the preferred embodiment, the computer connection utilized by the present invention is the Internet. This facilitates a computer connection for a customer, tower, and ASP who are geographically distant from each other. However, those skilled in the art can appreciate that the software will also function on a local area network or point to point or peer networks.

The tow management software is Java based for superior performance and incorporates modern, state of the art, click and drag features that are well known in the art.

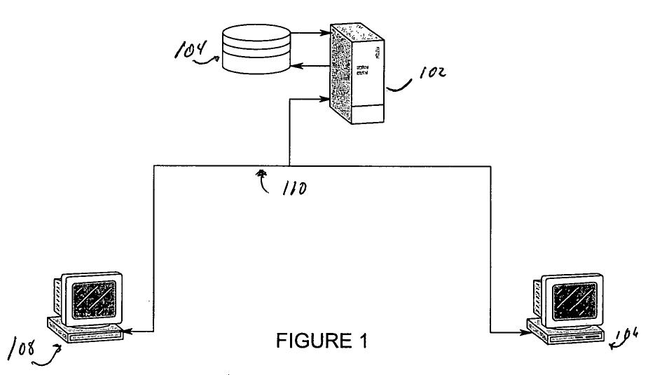

Referring to FIG. 1, there is shown a block diagram showing the typical hardware utilized in the preferred embodiment of the present invention. The server 102 is shown with storage 104 for the tow management system database. Typically, the server 102 would be provided by an ASP. However, it is contemplated that some tow companies may prefer to have their own server. A tower computer terminal 106 and a customer computer terminal 108 are connected to each other and the server 102 via a computer connection 110.

The server 102, tower computer terminal 106 and customer computer terminal 108 all have communications means for communicating with the computer connection. The various communications means which are well known in the art include, but are not limited to, serial communication, communication via a network interface card, or modem communications.

Access to the server 102 is granted to an account with a username and password. Anyone desiring access to the server 102 must first login. This enables one server 102 to serve a plurality of towers. Similarly, customer access to a tower computer terminal 106 with a username and password. Even though the customer computer terminal 108 and the server 102 utilize the same computer connection 110, the customer does not have direct access to the data on the server 102. If data the customer desires is stored on the server 102, the customer must first log into the tower computer terminal 106, the tower computer terminal would log into the server 102, the data would be sent from the server 102 to the tower computer terminal 106 which would then send the data to the customer at the customer computer terminal 108. Thus a plurality of servers 102, tower computer terminals 106 and customer computer terminals 108 may be connected to the same computer link 110. Furthermore, since the records stored on server 102 are associated to a tower, the ASP may charge a transaction fee for each tow transaction.

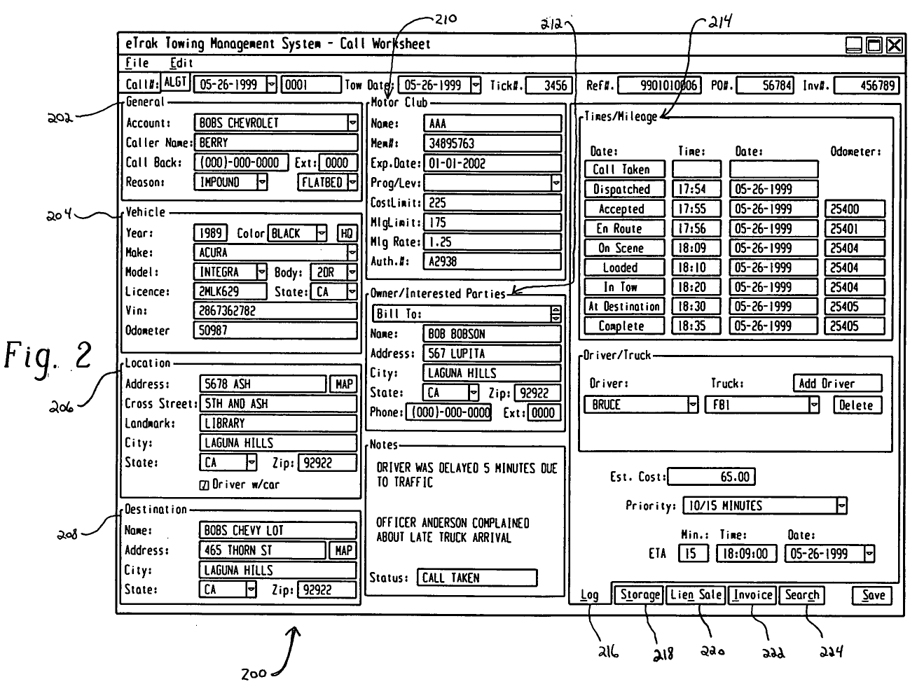

FIG. 2 is a detailed illustration of the main call taking screen 200. The screen is divided into several sections, each section containing information related to a certain aspect of the towing process. The general section 202 contains general details about the tow request. The vehicle section 204 contains a detailed description of the vehicle. The location section 206 stores a description of where the vehicle was towed from, whereas the destination section 208 stores the information relative to where the tow ultimately terminated. The motor club section 210 stores information regarding any motorist club coverage that may pay for the tow of any portion of the tow thereof. The owner/interested party section 212 is used to store information regarding who owns the vehicle being towed, or who was operating the vehicle at the time of the tow.

Approximately one third of the main call taking screen 200 is shared by various sections. This shared section 214 allows one of the underlying sections to be activated by clicking on one of the plurality of tabs at the bottom of shared section 214 with a mouse or other pointing device.

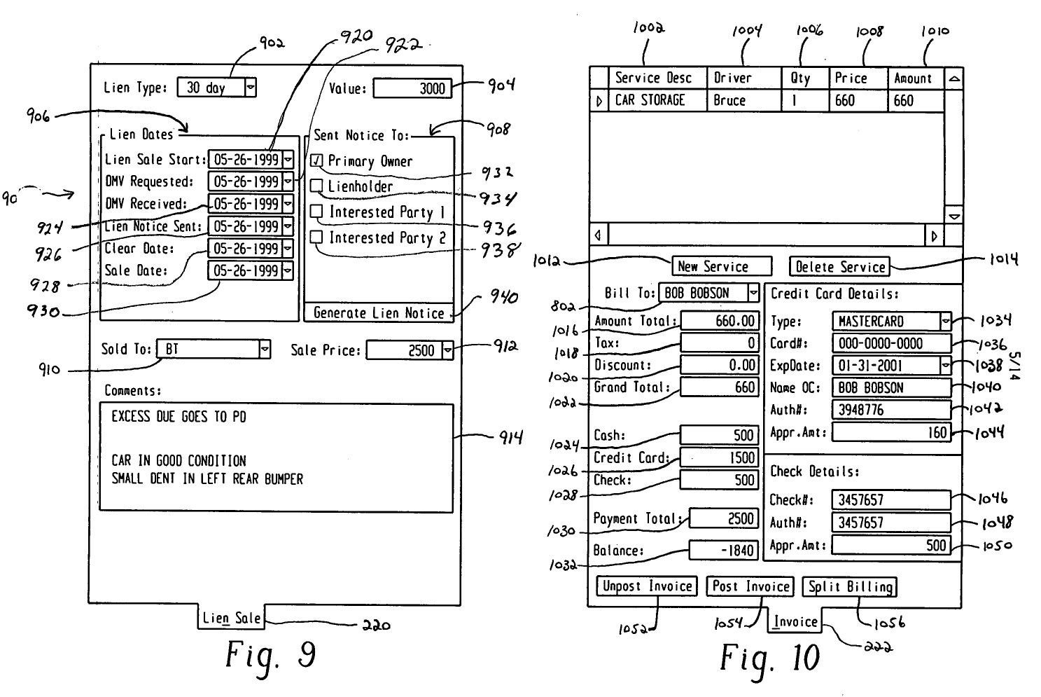

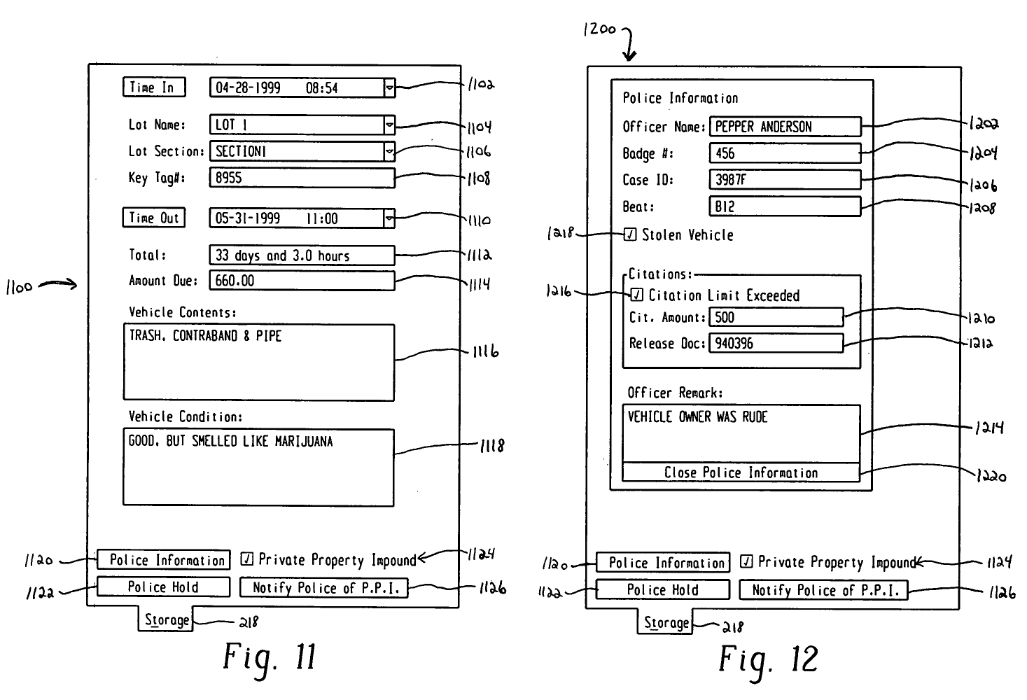

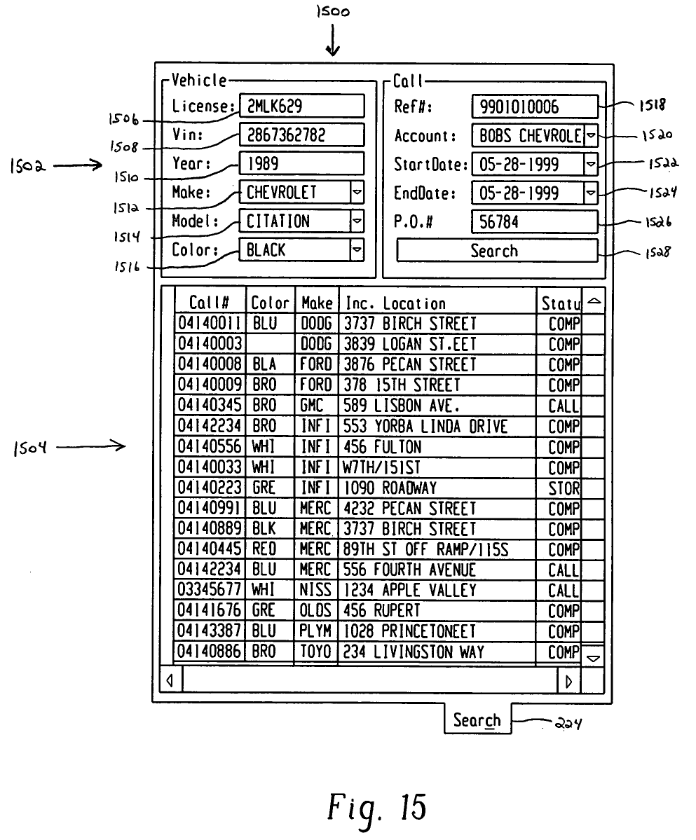

Tab 216 provides access to the Log Screen (FIG. 14), tab 218 to the Storage Screen (FIGS. 11-13), tab 220 to the Lien Sale Screen (FIG. 9) tab 222 to the Invoice Screen (FIG. 10) and tab 224 provides access to the Search Screen (FIG. 15). Clicking on the corresponding tab causes the selected screen to appear.

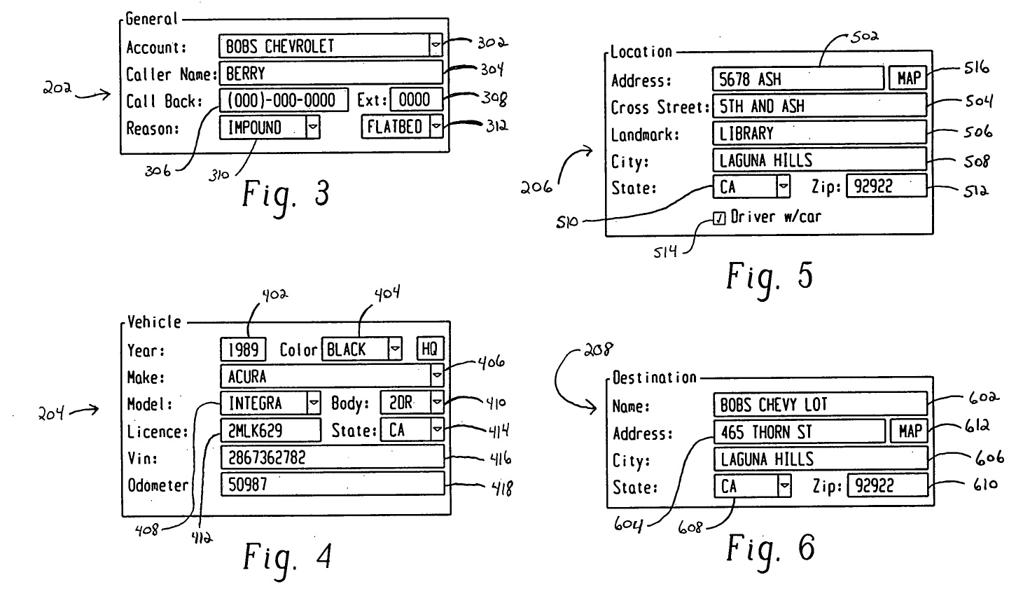

FIG. 3 is a detailed view of the general section 202 of the main call screen 200. The general section stores an account name 302 of who requested the tow, the name of the caller 304 who requested the tow, a call back number 306 and if applicable an extension number 308 for the caller 304. The reason field 310 requires a selection of pre-entered reasons for why the tow was ordered. The equipment 312 field enables the person handling the data entry task to specify what equipment is needed for the tow.

FIG. 4 is a detailed view of the vehicle section 204 of the main call screen 200. This section stores a detailed description of the vehicle being towed. The data fields in this section include the vehicle year 402, the vehicle color 404, the vehicle manufacturer 406, the manufacturer's model 408, the vehicle's body style 410, the vehicle license number 412, the state of registration 414 of the vehicle license number, the vehicle identification number 416 and the vehicle's current odometer reading 418.

FIG. 5 is a detailed view of the location section 206 of the main call screen 200. This section stores detailed information regarding where the tow was initiated. The fields in this section include the address 502, the nearest cross street 504 to the address, a description of any nearby landmarks 506, the city or locality 508, state 510 and zip code 512. Additionally checkbox 514 is checked if the driver of the vehicle is waiting on scene with the vehicle. Optionally, a map may be linked to the system. Pushbutton 516 provides a method for obtaining a map of the location, if available.

FIG. 6 is a detailed view of the destination section 208 of the main call screen 200. This section stores details about the final destination of the tow. The fields in this section include a business or other name or description 602 for the destination, the destination address 604, the city or locality 606, state 608 and zip code 610. Optionally, an interface to a mapping program may be included. If a mapping program is linked to the tow system, a map of the destination may be displayed by pressing pushbutton 612.

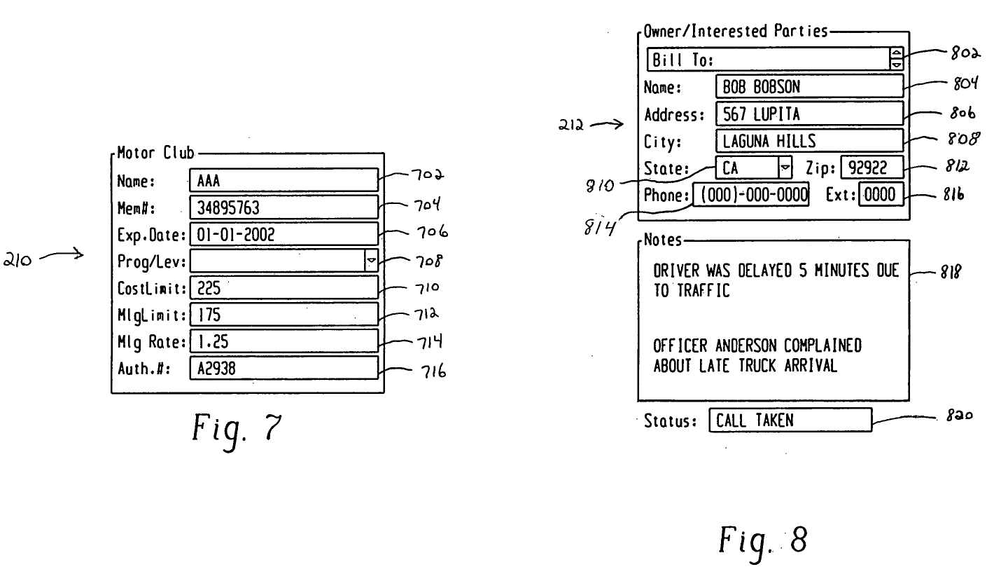

FIG. 7 is a detailed view of the motor club section 210 of the main call screen 200. If part or all of the cost of a tow will be paid by a motor club, information regarding the motor club and a description of covered services are stored in this section. The data fields for this section include the name 702 of the club, a member number 704 for the covered person, the membership expiration date 706, the membership program level 708, the payment cost limit 710, tow mileage limit 712, tow mileage rate 714 and if necessary an authorization number 716 provided by the motorist club. The payment cost limit 710 and tow mileage limit 712 fields enable a tower to determine when the services being provided exceed the motor club limits. Therefore a tower may notify a customer when the cost for a tow request will exceed coverage and obtain customer approval prior to accruing those charges. This also facilitates the proper allocation of billing charges.

FIG. 8 is a detailed view of the owner/interested parties section 212 of the main call screen 200. This section stores details regarding either the owner of the vehicle, the person requesting the tow, or the person who will pay for the tow. The fields include bill to 802 which stores the person or party that will pay for the tow, name 804, address 806, city 808, state 810, zip code 812 phone number 814 with extension 816 of the owner or interested party. A notes field 818 is provided for entering any free form notes about the tow. The status field 820 lists the current status of the tow request.

FIG. 9 shows the data stored when a previously towed vehicle is disposed via a lien sale. The lien sale screen 900 is activated by selecting tab 220 from the main call screen 200. The lien type 902 stores what type of activity triggered the lien sale. The value 904 field stores the listed value of the vehicle. The Lien dates 906 section of the lien sale screen 900 stores the pertinent dates relative to the sale. The lien dates section 906 stores Lien Sale Start 920 date, DMV Requested 922 date, DMV Received 924, Lien Notice Sent 926, Clear Date 928, and Sold date 930. The Send Notice to 908 section of the lien sale screen 900 records who was sent a notice regarding the pending lien sale of the vehicle. The fields in the sent notice to 908 section are checkboxes, allowing more than one notification to be stored. The party or parties notified may be the Primary Owner 932 of the vehicle, a Lienholder 934 of the vehicle, an Interested Party 1 936 of the vehicle and/or another interested party which is stored as Interested Party 2 938. Selecting pushbutton 940 allows a user to generate a notice. The sold to 910 field stores who purchased the vehicle at the lien sale while the sale price 912 field stores the sale price. The comments 914 field allows free form comments regarding the lien sale to be stored.

FIG. 10 shows the invoice screen 1000. This screen is displayed on the shared section 214 when tab 222 is selected. At the top part of screen 1000 are displayed data fields regarding tow services provided for a vehicle. These fields include the Service Destination 1002, Driver 1004, Quantity 1006, price 1008 and amount 1010. The new service pushbutton 1012 enables a new service to be added for a vehicle. Thus a single tow record can track a multiplicity of tow requests for one vehicle. The delete service pushbutton 1014 causes an erroneously entered service to be deleted from the system.

The left side of the invoice screen 1000 stores running totals regarding payments and amounts due for a vehicle. The amount total 1016 field stores and displays a running total of all the charges for a vehicle. The tax field 1018 is a running total of all tax that must be paid, for example sales tax, for transactions involving the vehicle. The Discount field 1020 allows for any discounts available to be taken. The grand total 1022 field is a calculated field comprising the running total of the amount total 1016, plus tax 1018, minus any discounts 1020. The cash field 1024 is a running total of all cash paid, the credit card 1026 field is a running total of all credit card payments and the check field 1028 is a running total of all checks paid. The payment total field 1030 is a running total of all payments received for a vehicle. The balance 1032 is a calculated field giving the current balance which is the grand total 1022 minus the payment total 1030.

The right hand side of the invoice screen 1000 is for entering and storing credit card or check payments. The credit car details stored for a credit card transaction include type of credit card 1034, card number 1036, expiration date of credit card 1038, name of cardholder 1040, charge authorization code 1042 and the amount paid 1044. The check details stored when payment is made by a check include the check number 1046, the authorization number 1048, and payment amount 1050.

There are three pushbuttons near the bottom of screen 1000 for handling the posting of transactions. The unpost invoice pushbutton 1052 is used to remove a posted invoice. This may be necessary when a credit card is rejected or a check is returned unpaid. The post invoice pushbutton 1054 is used to post a payment. Finally, the Split Billing pushbutton 1056 enables the splitting of customer invoices.

Clicking on the storage tab 218 will bring up one of the storage screens as shown in FIGS. 11-13. FIG. 11 is the vehicle storage screen 1100 which would normally be displayed when tab 218 is selected. The time in field 1102 logs the time the vehicle arrived at the storage facility. The lot name 1104 is a name assigned to a storage facility by the tower. The lot section 1106 further delineates the precise location where the vehicle is stored. The Key Tag# field 1108 stores a tag number which can be placed on the vehicle's keys so that the vehicle is not stored with the keys in the ignition. The time out field 1110 logs when the vehicle left the storage facility. The total field 1112 calculates the total amount of time a vehicle was stored at the storage facility. The amount due field 1114 calculates the amount due for a vehicle to be released. The vehicle contents field 1116 is a free form text field enabling the tower to describe the contents inside the vehicle. The vehicle condition field 1118 allows for a free form text description of the vehicle, it enables a tower to note damage to the vehicles and irregularities. The private property impound checkbox 1124 allows a tower to note when a vehicle is towed from private property at the request of the property owner. The Notify Police of PPI pushbutton 1126 enables a tow operator to notify a police department or other law enforcement agency that is utilizing a computerized law enforcement tow system.

For the Notify Police of PPI pushbutton 1126 to work, the law enforcement agency must be using a computerized system such as the Law Enforcement Tow System (“LETS”), available from eTrak, 3737 Birch Street, Newport Beach, Calif. 92660, Phone 949-567-7071. The law enforcement agency must have a computer connection, for example the Internet or a point to point connection, that allows the Tow Management System software to electronically exchange messages. Obviously, the Tower must also be connected to the computer connection

If the Police Information pushbutton 1120 is selected, the screen as shown in FIG. 12 is displayed. This screen stores data for tows that are ordered by a law enforcement agency. This information may either be filled in manually by a tow data entry operator or electronically. If the police or law enforcement agency is connected to the tower and using a compatible software program, such as the aforementioned LETS program, the tow request may be communicated from the law enforcement computer to the tow computer electronically via the computer connection or over the Internet, causing the fields in the police information screen 1200 as well as other pertinent data fields to automatically be populated. Otherwise, this data is manually entered.

The police information screen 1200 stores information for tows requested by a police or law enforcement agency. Some of the fields in this screen include the Officer's name 1202, officer's badge number 1204, case identification number or agency report number 1206 and police beat or zone 1208. Many police tows are for vehicles with overdue violations, this screen also includes a citation limit exceeded checkbox 1216 to denote when a vehicle has passed a threshold allowing it to be towed based on local law. The Cit. Amount 1210 is the amount of fines or citations that must be paid before the vehicle can be released. The release Doc 1212 field stores a document or file number generated for the release of the vehicle. The Officer Remark 1214 is a free text field allowing a police officer to make miscellaneous notes about the tow. The Close Police Information pushbutton 1220 is used to close this screen and return to the storage screen 1100.

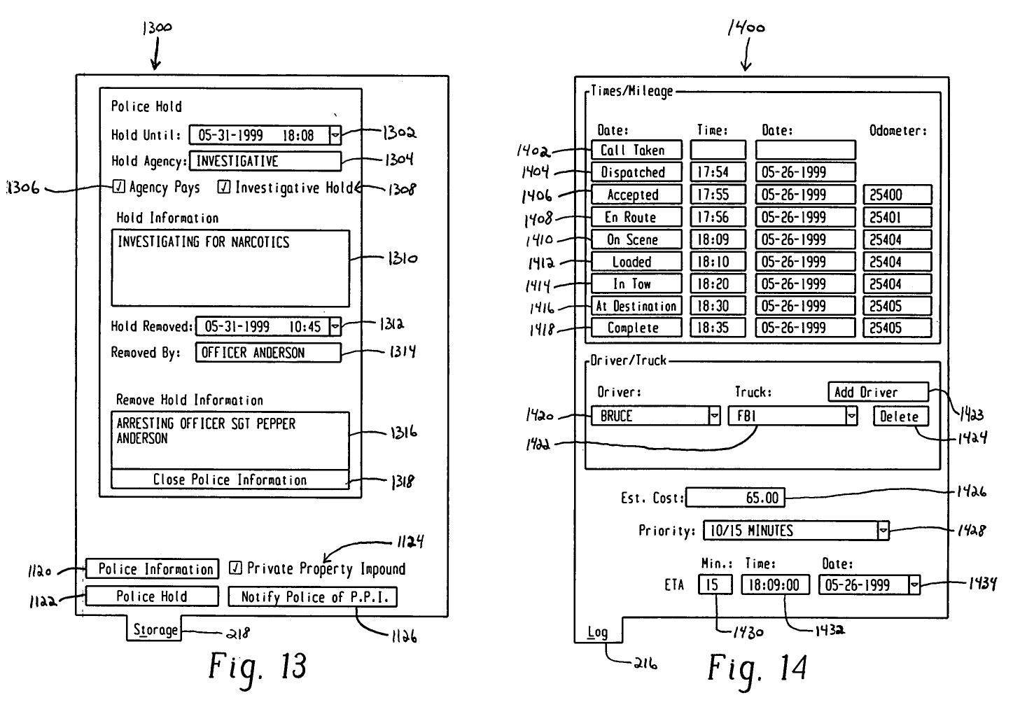

The police hold pushbutton 1122 provides access to the police hold screen 1300 (FIG. 13). This screen is used to store information when a law enforcement agency desires to prevent a vehicle from being released. This situation may arise when the law enforcement agency is holding a vehicle for evidentiary value or because evidence is located within the vehicle and the agency desires to obtain a search warrant. The hold until field 1302 can either denote an individual officer, patrol car number, or specialized unit within the law enforcement agency. The hold agency field 1304 may denote either a special unit within a law enforcement agency or the name of the specific agency. The agency pays checkbox 1306 is used to denote when the law enforcement agency will pay for the tow as opposed to the vehicle owner. The Investigative Hold checkbox 1308 is used to warn the tower that the vehicle is not to be released and the tower should not disturb the vehicle or its contents. The hold information field 1310 is a free text field where notes detailing the reason for the hold tow may be stored. When it is appropriate to release the vehicle, the law enforcement agency may remove the hold. The time and date that the hold is removed is stored in the Hold Removed field 1312. The removed by field 1314 stores the officer or person from the law enforcement agency who authorized the removal of the hold. The remove hold information field 1316 is free text field allowing miscellaneous notes or details about the release of the hold to be stored. Finally, selecting the close police information pushbutton 1318 closes this window and returns to the vehicle storage screen 1100.

Selecting the log tab 216 from the main call taking screen 200 causes the Times/Mileage screen 1400 to be displayed. This screen tracks various milestones of the towing process. If the tow truck operator is equipped with a mobile data terminal, this data may be entered automatically by the tow truck operator at the mobile data terminal and then transmitted to the Tow Management System which is then updated automatically, without the need of any additional data entry. The milestones stored and displayed on this screen include when the call was taken 1402 (date and time) when the call was dispatched to a tow truck or other towing equipment was summoned 1404 (date and time), when the tow truck operator accepted the call 1406 (date, time and a current odometer reading of the tow truck), when the tow truck operator actually was enroute to the destination 1408, the time the truck arrived at the scene 1410 (date, time and a current odometer reading of the tow truck), the time the vehicle was finally loaded onto the truck 1412 (date, time and a current odometer reading of the tow truck), when the tow truck operator actually started the tow 1414 (date, time and a current odometer reading of the tow truck), when the tow truck operator arrived at the destination 1416 (date, time and a current odometer reading of the tow truck) and when the tow truck operator finally completed the tow 1418 (date, time and a current odometer reading of the tow truck).

This screen also stores the tow truck driver 1420 and truck number 1422 that handled the call. The add driver pushbutton 1423 is used to add a new or additional driver to the current active list of available drivers or tow vehicles. If another driver handles the call, the delete pushbutton 1424 can be utilized to remove the original tow driver from the call.

The Est. cost field 1426 allows for cost estimates to be stored. The priority field 1428 is useful in assigning tows when there are a plurality of tows pending. The estimated time that a tow truck driver expects to take in order to arrive at a tow scene can be stored in the ETA field 1430 along with the time 1432 the driver is expected to arrive as well as the date 1434 the driver expects to arrive.

FIG. 15 shows an example of the Search screen 1500. This screen allows for quick searches by vehicle description or call information. The types of searches available with this system are not limited to the fields shown on this screen. The search screen 1500 is divided into two sections. The upper section 1502 is where the search parameters are entered. The lower section 1504 displays the results of the search.

A search may be made by vehicle license 1506, Vehicle Identification Number 1508, Vehicle year of manufacture 1510, vehicle manufacturer 1512, vehicle model 1514 and vehicle color 1516. Additionally, this screen allows for certain call parameters to be searched, such as the call's reference number 1518, or the customer account 1520, or purchase order number 1526. The search may also limit the replies to tows within a certain period defined by the start date 1522 and the end date 1524. Once the desired parameters are input, selecting the search pushbutton 1528 will cause the results to appear at the bottom section 1504 of the screen 1500.

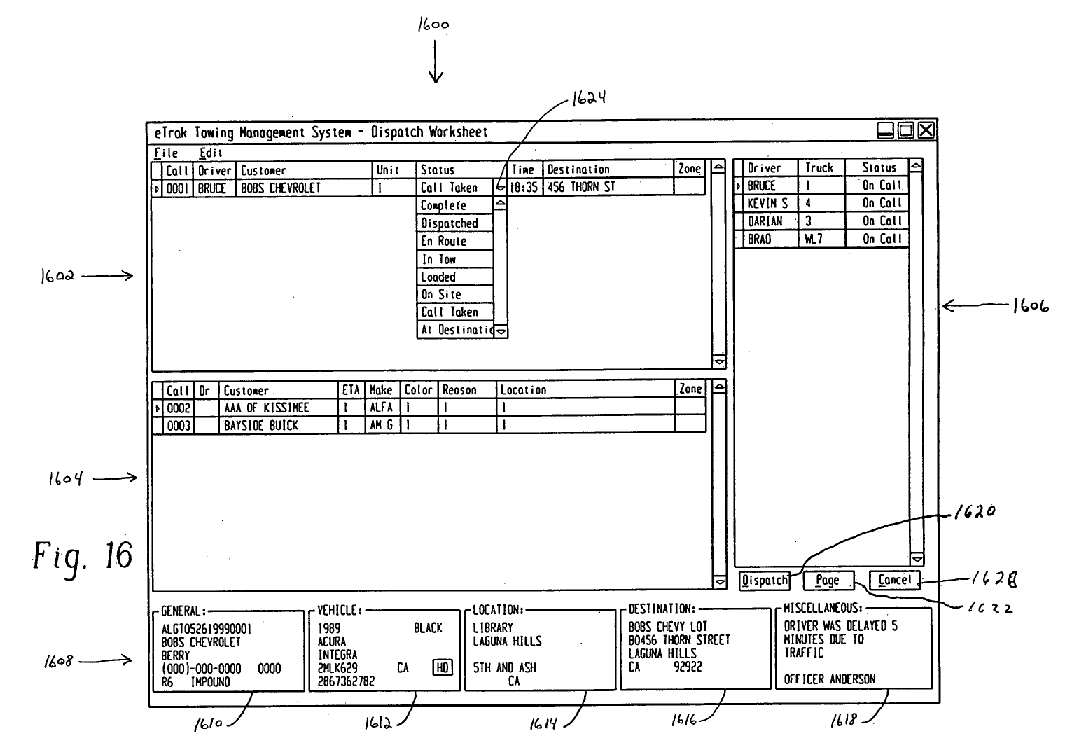

Referring to FIG. 16, the preferred embodiment of the Dispatch Worksheet screen 1600 is illustrated. This screen is divided into four major sections. The first section 1602 shows vehicles in the process of being towed. The second section 1604 shows vehicles that have outstanding tow requests, but no truck has been assigned. The third section 1606 lists the trucks or tow vehicles currently in operation. Finally the fourth section 1608 shows additional details for a tow request for a vehicle selected either from the first section 1602 or the second section 1604.

The fourth section 1608 is subdivided into five subsections. The first subsection 1610 shows general call details such as account information and who requested tow, the second subsection 1612 displays a description of the vehicle, the third subsection 1614 displays the location for the tow request, the fourth subsection 1616 displays the tow's destination, and the fifth subsection 1618 displays miscellaneous information about the tow request.

There are several methods that can be utilized for initiating a tow request and having the request appear at the bottom section 1604 of the dispatch worksheet screen 1600. One method would be to manually create a new record on the dispatch worksheet screen 1600. A user at the computer could either use the file menu and select, add a new request or a shortcut can be placed on the screen 1600 for the user to utilize to add a new tow request. The vehicle description, location and various other fields would then be manually entered.

An alternative method for initiating a tow request on the bottom section 1604 of screen 1600 would be to utilize a remote computer terminal at a remote location. The remote terminal could be connected by a computer connection, for example a local area network or the Internet. A data entry person at the remote terminal then receives the tow request, enters it into the Tow Management System where it is then caused to appear on the bottom section 1604 of screen 1600 for dispatching. This would allow a plurality of terminals to be used for receiving requests.

For example, a law enforcement agency connected to the tow management system by a computer connection such as the Internet or a point to point or peer network connection, utilizing the aforementioned LETS system could input a tow request into the law enforcement computer system and have that request automatically appear on the bottom section 1604 of screen 1600 as an unassigned tow request. A tow dispatcher then dispatches the tow. This same method may also be used by auto clubs or large volume customers.

There are several ways an unassigned tow request may be assigned to a tow truck. One way would be for the tow dispatcher to contact the tow truck via radio and assign the truck the tow. The dispatcher would then manually move the tow from the bottom section 1604 (unassigned) to the top section 1602 (assigned). This can be done by using a pointing device such as a mouse to select the unassigned tow, and then select a driver for the tow from the third section 1606. A second method of manually moving the unassigned request would be to use a pointing device such as a mouse to select the unassigned tow and drag the unassigned tow from the bottom section 1604 and drop into the upper section 1602 (assigned) of the dispatch worksheet screen 1600 and either manually entering a driver or selecting the driver from the third section 1606. The dispatcher could then use a pull down menu 1624 to change the status of the tow. Each time the dispatcher changes the tow's status, the time and status is logged. Subsequently, the changes in status may be viewed using the Times/Mileage screen 1400 (FIG. 14).

Another method is available to assign an unassigned tow to a truck when the truck is equipped with a mobile data terminal. This method contemplates that the dispatcher utilizing a mouse or other similar pointing device selects the tow to be assigned from the bottom section 1604, then selects a driver from the third section 1606, and then selects the dispatch pushbutton 1620. Upon selection of the dispatch pushbutton 1620, the tow is assigned to the driver selected in the third section 1606, whereupon the system then automatically moves the unassigned tow request from the bottom section 1604 to the top section 1602, automatically changes the status of the tow request to dispatched and the change of status is logged into the database, and the tow request is then sent to the tow truck's mobile data terminal.

Yet another method is available to assign an unassigned tow to a truck when the truck or driver is equipped with a pager. This method contemplates that the dispatcher utilizing a mouse or other similar pointing device selects the tow to be assigned from the bottom section 1604, then selects a driver from the third section 1606, and then selects the page pushbutton 1622. Upon selection of the page pushbutton 1622, the tow is assigned to the driver selected in the third section 1606, whereupon the system then automatically moves the unassigned tow request from the bottom section 1604 to the top section 1602, automatically changes the status of the tow request to dispatched and the change of status is logged into the database, and a page is sent to the pager. Selection of the cancel pushbutton 1626 will cancel the most recent dispatch or dispatch pending request.

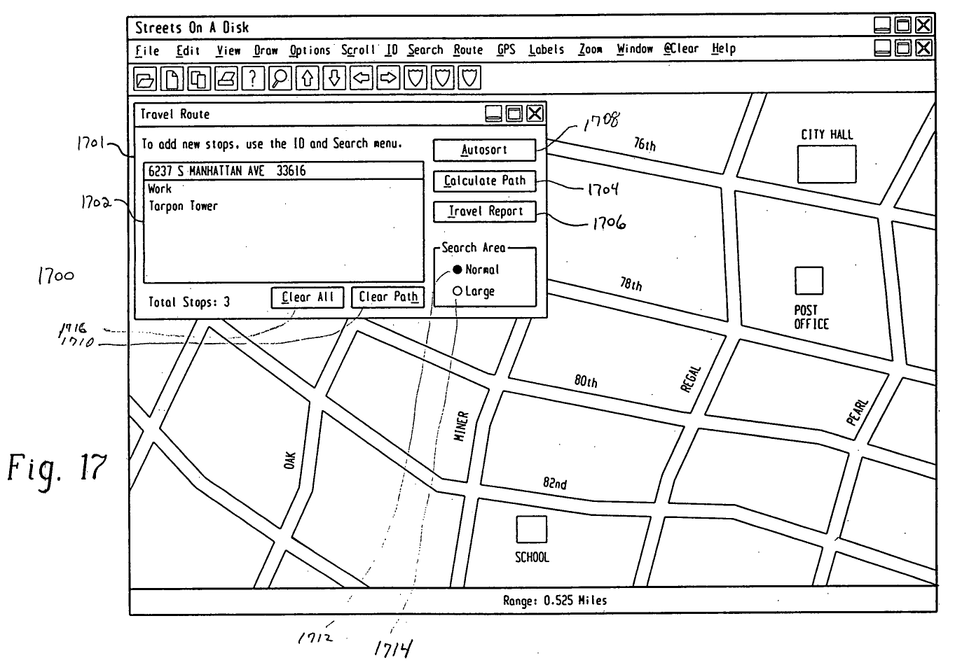

In order to aid a tow dispatcher in locating the closest available tow truck available to handle a tow request, the trucks may be equipped with a global positioning system. The global positioning system may be used in conjunction with a map as shown in FIG. 17. The map 1700 not only assists a dispatcher in locating the closest unit to respond, but can be used to view a truck's activity as well. Once a truck is selected, the travel route window 1701 can be used to show calls that the truck has either already handled, is currently handling, or are waiting for service. These calls are provided in a list 1702 format. A suggested or expected path for the truck to travel can be calculated using the calculate path pushbutton 1704. The travel report pushbutton 1706 will display historical data. The autosort pushbutton 1708 is used to automatically sort all available units to aid the dispatcher in locating the closest unit to respond. The clear all 1716 and clear path 1710 pushbuttons cancels either all activities or the most recently assigned activity respectively for the most recently selected truck. In the lower right side of the travel route window 1701 is a box entitled Search Area, containing a two radio button fields that control the search area for locating nearby tow trucks. The normal 1712 radio button searches for tow trucks within a pre-defined vicinity of the tow request, the large 1714 radio button will search for tow trucks inside and outside of the pre-defined vicinity that the normal 1712 radio button is set to search for.

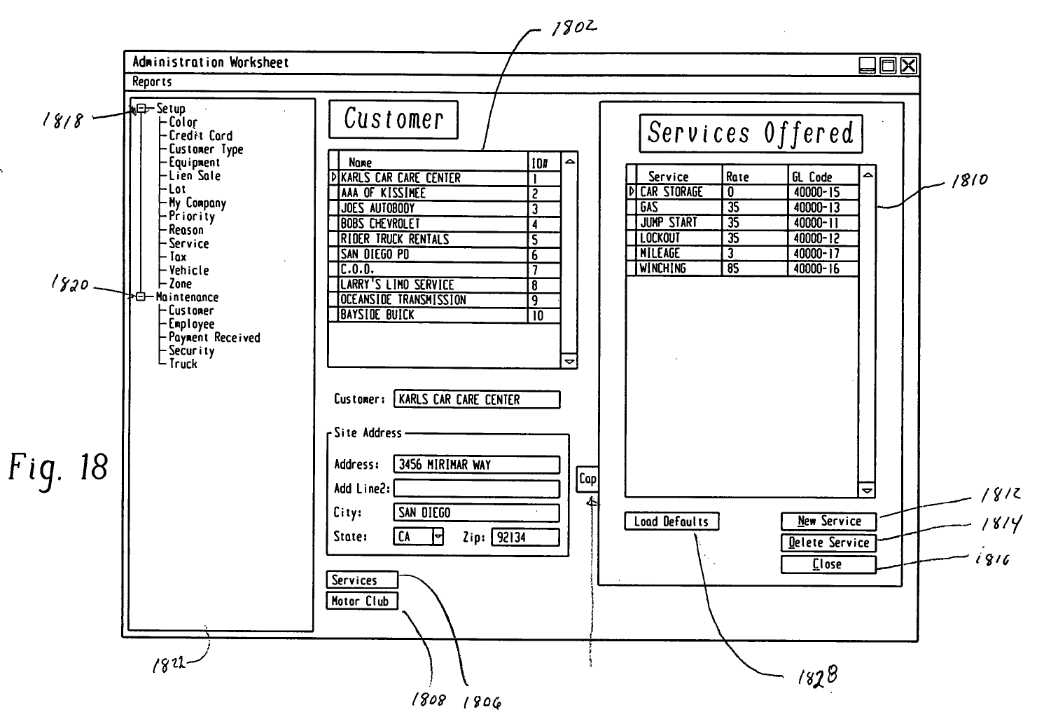

FIG. 18 is an example of the customer information screen 1800. The customer information screen 1800 stores various details about a customer and various services available to that customer. The details of a customer record 1804 may be displayed by selecting from a customer list 1802. After a customer record is displayed, either the services offered the customer or motor club details may be displayed or edited.

The services screen 1810 is displayed after the services pushbutton 1806 is selected. The services screen 1810 allows the various services for a customer to be setup. The Load Defaults 1828 pushbutton allows the Services Offered list to be loaded with default customer services which can be setup by a system administrator. The New Service 1812 pushbutton allows a new service to be associated with a customer while the Delete Service 1814 pushbutton removes a service from the customer profile. The Close 1816 pushbutton closes the services screen 1810.

When the motor club pushbutton 1808 is selected a subscreen similar to FIG. 7 for entering various motor club details such as motor club number, authorization number, mileage and cost limits is activated. This enables motor club information to be associated with a customer.

The left section of the screen 1822 has tree menus for administrative setup. Within the setup tree 1818 an administrative user may select setup defaults and enter data for companies, customers, trucks, employees, payment processing and lien sales.

Within Company Setup, a plurality of information is available for entry such as Company Profile, which provides contact, address, and tracking details of the company. Group Information regarding any grouping within the company, Security which creates and manages user accounts by selecting which parts of the system each user has access to, Registration which is used to authorize and activate the installed copy of TMS and finally the System Defaults which enable limits to be placed on each element described on each screen or function.

Similarly, the Customers, Trucks and Employees section enable the user to define each element used by the system such as name, address, payment terms, discounts etc. Employee information is used to set up driver information including license number, commission or hourly rate payments, hire and termination dates etc.

Truck Setup provides all information associated with the tow vehicles used such as Class, Description, Equipment type, License number, Registration dates, Permit numbers, VIN number, In or Out of Service information and code.

Payment processing allows different types of payment information to be posted to customer accounts such as add new payment, create credit memo, pay credit memo and a general search function by customer name and/or number.

The Reporting function is divided into two sections: Accounting and Management. The Accounting section contains standard reports such as Account Summary, Daily Revenue, Driver Commission, Invoice Register, and Sales Analysis. The Management section also contains standard reports such as Call Log, Cancelled Calls, Customer List, Truck List, Lot Inventory, Released Vehicle, and Employee Listing.

The Lien Sale Processing section activates the Lien Generation functions such as the initiation of Lien Sale by vehicle, start dates, and customer information. Additionally, Lien Sale Reports, Lien Letters and Lien Status information is generated from this section.

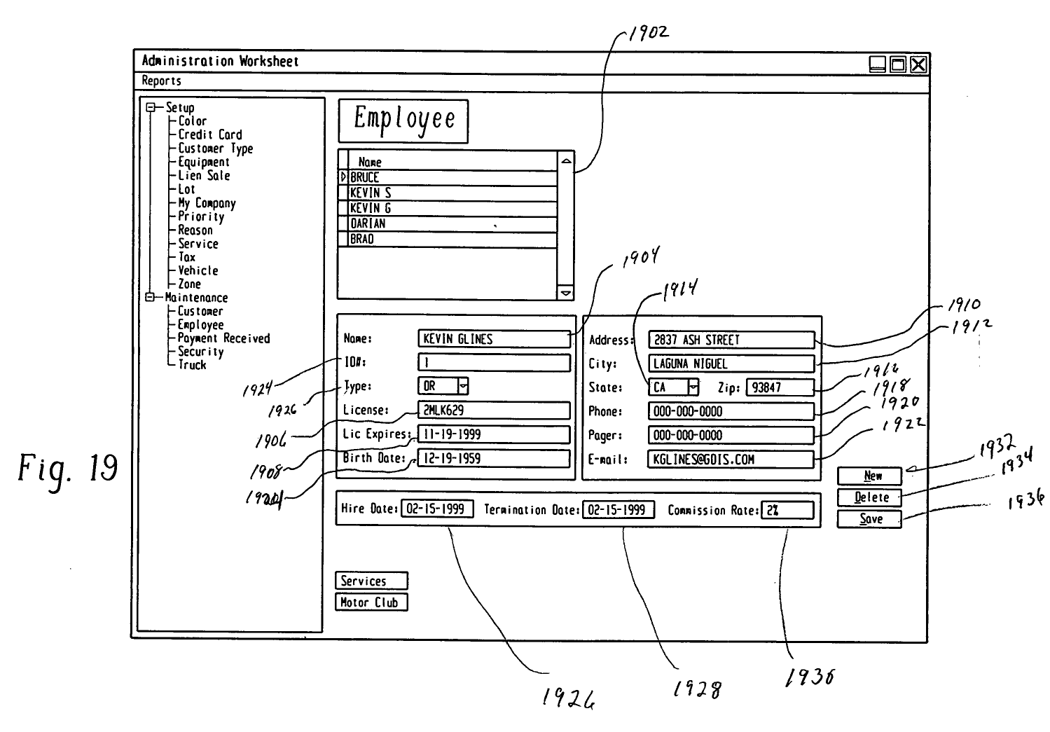

FIG. 19 shows an example of the employee information screen 1900. The employee information is displayed by selecting an employee from the employee list 1902. While this screen displays standard employee information such as employee name 1904, employee address 1910, employee city 1912, employee state 1914, employee zip 1916, employee phone number 1918, employee pager number 1920 and employee e-mail 1922. Additionally, the employee screen 1900 also stores employee operator license number 1906 and the operator license expiration date 1908, enabling a tow operator to be notified when an employee's license is about to or has expired. The employee screen also stored the employee's birth daet 1924, the hire date 1926, termination date 1928 and a commission rate 1930. The new 1932 pushbutton allows entry of a new employee. The delete 1934 pushbutton deletes an employee from the database. The save 1936 pushbutton saves the information currently displayed on the screen 1900.

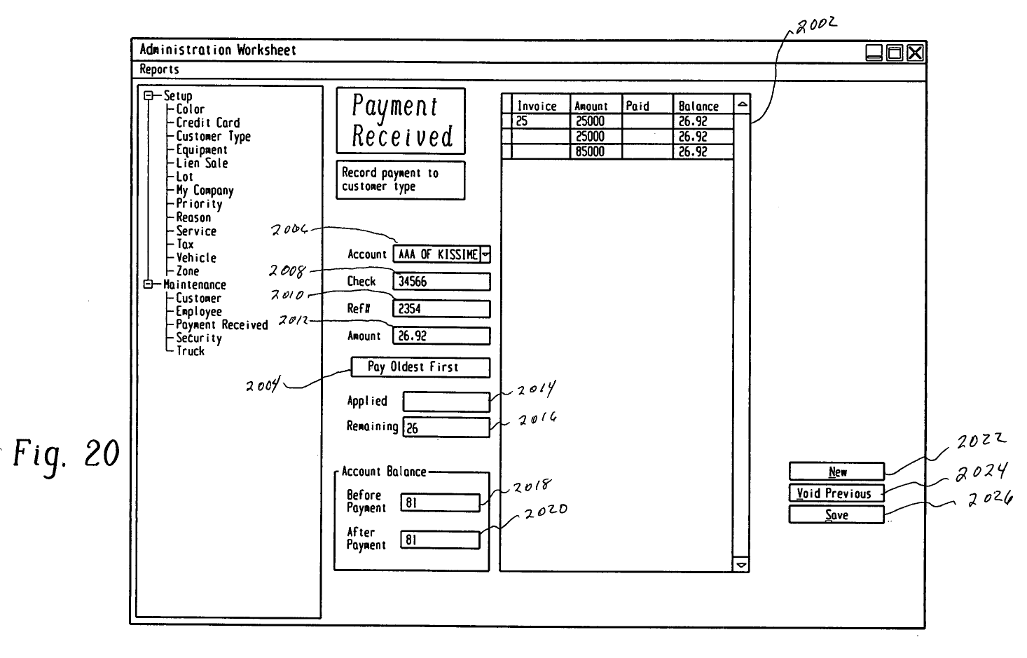

FIG. 20 is an example of a payment received screen 2000. This screen is used to log the payment of invoices. A user selects the new pushbutton 2022 to enter a new payment. Then the user selects an account 2006 which causes a list of invoices due 2002 to be displayed. By using the pay oldest first pushbutton 2004, a single payment may be split over a plurality of due invoices, with priority given based on the age of the invoice. There are also fields for check number 2008, reference number 2010, and amount 2012. The applied 2014 and remaining 2016 fields enable a payment of a specific amount to an individual invoice. Additionally account balances are automatically calculated and updated. The before payment field 2018 shows the previous account balance before the last payment was received, the after payment field 2020.

To split an invoice, first the account 2006 is selected. Then the check number 2008, reference number 2010 and amount 2012 are input. The applied 2014 and remaining 2016 fields then track how much of the check has been distributed among the various invoices owed by the customer and automatically updated. Initially, upon first entering a check, the applied field 2014 would have a zero balance while the remaining field 2016 would be equal to the amount of the check or payment. At this point the user has the option of paying the oldest invoice first by pressing the pay oldest first pushbutton 2004 or may select an invoice from the list 2002. After selecting an invoice to pay, the user then may elect an amount to pay on that specific invoice. After the user has decided how much of the payment to apply to the selected invoice, the applied field 2014 is updated to denote how much of the payment has been applied to invoices while the remaining field 2016 is automatically updated to reflect if there are additional funds left after the payment If there are funds left, then the process of selecting an invoice, and an amount to pay on the selected invoice is repeated until remaining funds stored in the remaining field 2014 is zero or all of the invoices are paid. If all of the customer's invoices are paid and the remaining field is non-zero, the system will store the credit for use with future invoices.

When the user has completed filling out the data fields, the save pushbutton 2026 then posts the transaction.

The void previous pushbutton 2024 is used when a previously posted payment is rejected. This can occur when a credit card is rejected or a check is rejected for non-sufficient funds or is written on a closed account. The user highlights the rejected payment selects the void previous pushbutton 2024. The payment is then automatically deleted and the account balance is recalculated.

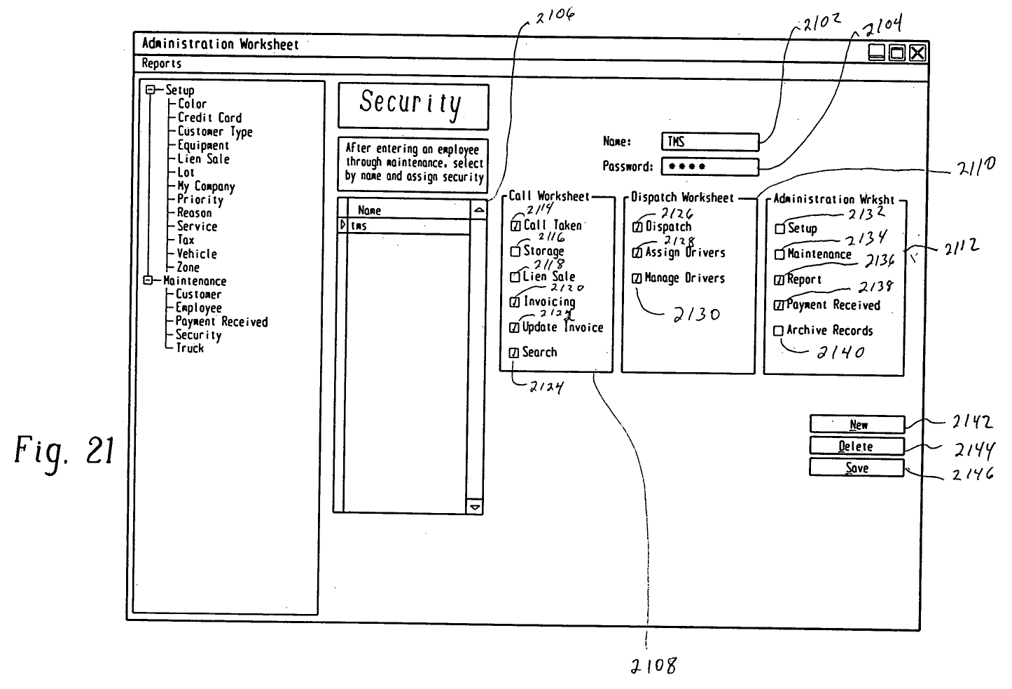

FIG. 21 is an example of the security configuration screen 2100. The security configuration screen 2100 enables the security for each individual or employee to be specifically tailored to that persons access needs. In order to access the features of this screen, a user must first login with their name in the name field 2102 and password in the password field 2104. Once logged in, new users may be added to the system by selecting the new pushbutton 2142, users may be removed by selecting the delete pushbutton 2144 or a user's security parameters may be modified by selecting a user from the name list 2106.

After selecting the type of transaction, the user is presented with a screen divided into three sections. The first section, the call worksheet section 2108, enables security access to be set for the various screens associated with the call worksheet screen (see FIG. 2). The second section, the dispatch worksheet section 2110, enables security access to be controlled for the various sections of the dispatch worksheet screen (see FIG. 16), and the third section, the administrative worksheet 2112 enables access to be controlled for miscellaneous administrative screens. When a check is inserted into a checkbox it means access for that field has been enabled. If there is no check in the checkbox, the system will not allow access to the associated screen or field.

Referring to the call worksheet section 2108, a plurality of checkboxes are displayed that enable access to be controlled for the various screens associated with the call worksheet screen (FIG. 2). The call taken checkbox 2114 determines if the user will have access to the log screen 1400 as shown in FIG. 14. The storage checkbox 2116 control access to the vehicle storage screen 1100 (FIG. 11) as well as the police information screen 1200 and the police hold screen 1300. The lien sale checkbox 2118 controls access to the lien sale screen 900. While the invoicing checkbox 2120 controls access to the invoice screen 1000, the update invoice checkbox 2122 determines if the user may make edits to the invoice screen 1000. The search checkbox 2124 controls access to the search screen 1500.

The dispatch worksheet section 2110 controls access to various parts of the dispatch screen 1600. The dispatch checkbox 2126 determines if a user can access the dispatch screen 1600. If a user can access the dispatch screen 1600 then the assign drivers checkbox 2128 and manage drivers checkbox 2130 determine if that user can assign a tow request to a driver and if the user can insert or remove drivers from the third section 1606 of screen 1600 respectively.

The administrative worksheet section 2112 section controls access to the various system administrative functions. The setup checkbox 2132 determines whether the user can change the system setup that allows access to tow companies setup functions, services, contained within the administrative worksheet 2112 section. The maintenance checkbox 2134 determines whether the user can modify any of the previously defined functions.

The report checkbox 2136 determines whether the user has access to the various system reports. Report are divided into two sections: Accounting and Management. The Accounting section contains 14 standard reports such as Account Summary, Daily Revenue, Driver commission, Invoice Register, and Sales Analysis. The Management section also contains 14 standard reports such as Call Log, Cancelled Calls, Customer List, Truck List, Lot Inventory, Released Vehicle, and Employee Listing.

The Payment Received checkbox 2138 determines whether the user can access the payment received screen 2000.

Finally, the archive records checkbox 2140 determines whether the user can take old records off line and archive them separately.

Selecting the save 2146 pushbutton will save any changes made to the call worksheet 2108, the dispatch worksheet 2110 or the administration worksheet 2112.

Although the invention has been shown and described with respect to a certain preferred embodiment, it is obvious that equivalent alterations and modifications will occur to others skilled in the art upon the reading and understanding of this specification. The present invention includes all such equivalent alterations and modifications and is limited only by the scope of the following claims.

1. A system for managing tow operations information comprising:
a. an application server including database server means to electronically store data and means to access and transmit data in response to user commands and communication means;
b. a computer workstation associated with a tower, the computer workstation including display means, input means, and communication means;
c. a computer connection electronically linking the computer workstation to the application server;
d. user application means for receiving a tow request data;
e. communications means for sending the tow request data to the application server so that the database server may store the tow request data

2. The system for managing tow operations information as in claim 1 further comprising user application means for inputting lien sale data, means for associating the lien sale data with the tow request, and storing the lien sale data on the application server with the tow request data.

3. The system for managing tow operations as in claim 1 wherein the application means for receiving tow request data includes means for electronically receiving tow request data from a tow customer computer workstation utilizing the communications means.
